(19) United States
(12) Patent Application Publication
(10) Pub. No.: US 2011/0285501 A1
(43) Pub. Date: Nov. 24, 2011

(54) ELECTRONIC LOCK WITH SCREEN

(76) Inventor: Ming-Hwei CHEN, Taipei City (TW)

(21) Appl. No.: 13/037,946

(22) Filed: Mar. 1, 2011

(30) Foreign Application Priority Data
May 21, 2010 (TW) 099209576

(51) Int. Cl. G06F 7/04

(52) U.S. Cl. 340/5.7

(57) ABSTRACT

An electronic lock with a screen includes an outer base body and an inner base body. The outer base body and the inner base body are correspondingly installed on inner and outer sides of a door for controlling the door to be open or locked. The outer base body is disposed with an image pickup element for obtaining an image of a visitor standing outside the door. The inner base body is disposed with a screen electrically connected with the image pickup element for displaying the image obtained by the image pickup element, so that an indoor user may know an identity of the visitor paying a visit in real time.

### BACKGROUND OF THE INVENTION

1. Field of the Invention

The present invention relates to an electronic lock with a screen, and more particularly to an electronic lock with an image pickup element disposed on an outer side and a screen disposed on an inner side, so that an indoor user may obtain an image of a visitor outside a door.

2. Related Art

From ancient times, every country faces a burglary problem. Generally speaking, thieves cannot be effectively prevented, and a burglary detection rate is not high. Therefore, it is vital important to lower the possibility of burglary. Currently, various anti-burglary measures, such as a security system and an image monitoring system, are adopted to prevent the occurrence of burglary. However, various locksets are popularly applied for the anti-burglary measures of common houses.

For an electronic lock that is usually used currently, a battery supplies power to a magnetic valve or a motor, and then an indoor person controls the magnetic valve or the motor to actuate through a switch, so as to release the control of the lock and open the door. However, the conventional electronic lock only has unlocking and locking functions, but fails to enable the indoor person to know who the visitor is and to have a conversation with the visitor, so another set of interphone with a screen should be purchased additionally. In this way, the user will have a higher purchasing cost and installation troubles.

In view of the above, in order to eliminate the shortcomings, make the electronic lock with the screen have functions of the electronic lock, enable the indoor person to catch sight of the visitor, and reduce the purchasing cost and the installation time, the present invention is finally proposed after years of experience and continuous research of the inventor.

### SUMMARY OF THE INVENTION

The present invention is directed to an electronic lock with a screen, which may reduce a cost for purchasing an interphone with a screen and an electronic lock, and decrease time for respectively installing the interphone and the electronic lock.

The present invention is also directed to an electronic lock with a screen, which divides an indoor inner base body into a structure of a base and a mobile machine body, so that an indoor user may move the mobile machine body with the screen to every indoor corner or floor, so as to know an identity of a visitor paying a visit in real time, and control the electronic lock to be unlocked via remote control, thereby enabling entrance of the user.

The present invention is further directed to an electronic lock with a screen, which divides an indoor inner base body into a structure of a base and a machine body having the screen and capable of being charged on the base, so that an indoor user may use the mobile machine body in every indoor corner or floor, and the machine body may be charged continuously when being not used.

The present invention is further directed to an electronic lock with a screen, which stores an image of a visitor, and displays the image on the screen of an indoor inner base body, so that an indoor user may know which visitors paid a visit before according to stored image data.

In order to achieve the above objectives, the present invention provides an electronic lock with a screen, which includes an outer base body and an inner base body. The outer base body is installed on an outer side of a door, and the inner base body is installed on an inner side of the door. The inner base body and the outer base body are correspondingly installed on two sides of the door for controlling the door to be open or locked. Main technical features thereof lie in that, the outer base body is disposed with an image pickup element for obtaining an image of a visitor standing outside the door; and the inner base body is disposed with a screen for displaying the image obtained by the image pickup element.

During implementation, the outer base body is disposed with a first microphone and a first megaphone, and the inner base body is disposed with a second microphone and a second megaphone. The first microphone is electrically connected with the second megaphone, so that voice of the visitor outside the door may be transmitted inside the door. The second microphone is electrically connected with the first megaphone, so that voice inside the door may be transmitted outside the door.

During implementation, the inner base body includes a base and a mobile machine body. The base is disposed with a bearing portion for connecting the mobile machine body to the base.

During implementation, the base is disposed with a Universal Serial Bus (USB) socket, and the mobile machine body is disposed with a USB plug for being correspondingly plugged in the USB socket.

During implementation, the inner base body is disposed with a circuit board, and the circuit board is disposed with a memory electrically connected with the image pickup element for recording the image obtained by the image pickup element.

During implementation, the outer base body is disposed with a magnetic valve, and is connected with a power supply for controlling the door to be open or locked. The base is disposed with a signal receiver, the signal receiver is connected with a switch, and the switch is electrically connected with the magnetic valve and the power supply. The mobile machine body is disposed with a signal transmitter, so that the user may control the door to be open after the signal transmitter outputs a signal to the signal receiver.

During implementation, the signal receiver is an infrared signal receiver, and the signal transmitter is an infrared signal transmitter. The signal receiver may also be a Bluetooth signal receiver, and the signal transmitter is a Bluetooth signal transmitter.

In order to make the present invention more comprehensible, the present invention is described in detail hereinafter.

### BRIEF DESCRIPTION OF THE DRAWINGS

The present invention will become more fully understood from the detailed description given herein below for illustration only, and thus are not limitative of the present invention, and wherein:

FIG. 1 is a schematic three-dimensional outside view of a first embodiment of the present invention;

FIG. 2 is a schematic three-dimensional outside view of an inner base body according to the first embodiment of the present invention;

FIG. 3 is a schematic exploded view of elements of an inner base body according to a second embodiment of the present invention; and

FIG. 4 is a schematic structural view of a power supply component according to the present invention.

### DETAILED DESCRIPTION OF THE INVENTION

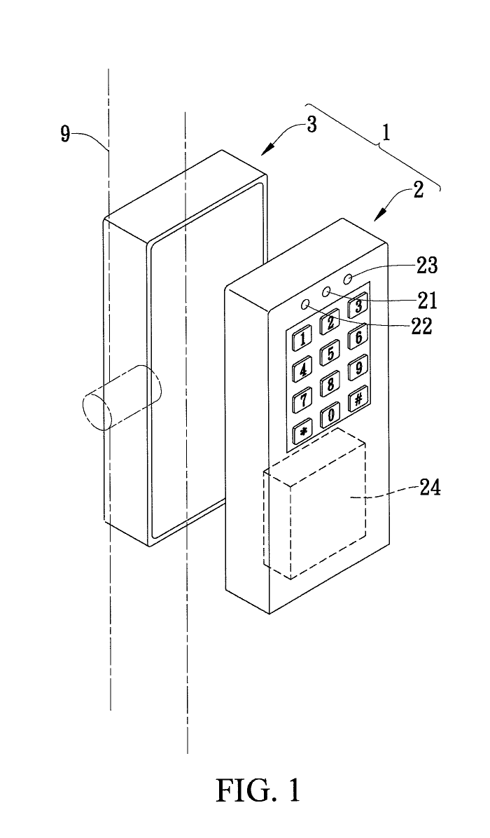

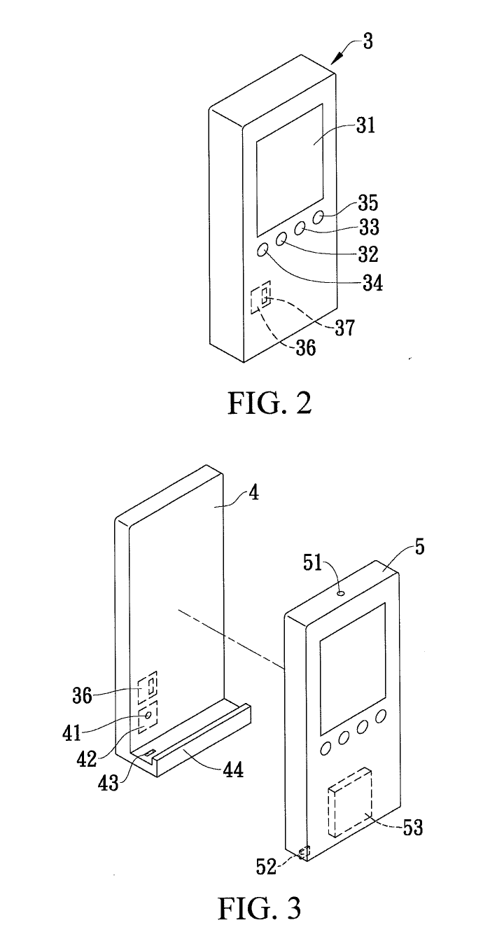

FIGS. 1 and 2 show a first embodiment of an electronic lock 1 with a screen according to the present invention. Referring to FIGS. 1 and 2, the electronic lock 1 with the screen mainly includes an outer base body 2 and an inner base body 3. The outer base body 2 and the inner base body 3 are correspondingly installed on inner and outer sides of a door 9. In addition, the outer base body 2 is disposed with a magnetic valve 24, and the magnetic valve 24 is connected with a power supply and a switch for controlling the door 9 to be open or locked. The outer base body 2 may also be disposed with a motor and a structure linked up with the motor, so that a user may control the switch to enable the structure linked up with the motor to release a locking state when the motor rotates. A structure of the electronic lock is a common conventional technology, and will not be described herein again.

Main technical features of the present invention lie in that, the outer base body 2 is disposed with a Charge Coupled Device (CCD) image pickup element 21 on a side facing a visitor, in which the image pickup element 21 may also be a Complementary Metal-Oxide-Semiconductor (CMOS) image pickup element. The inner base body 3 is disposed with a Liquid Crystal Display (LCD) screen 31 on a side facing an indoor user, in which the screen 31 is electrically connected with the image pickup element 21, so that the image pickup element 21 obtains an image of the visitor standing outside the door, and the screen 31 displays the image obtained by the image pickup element 21.

Further, the outer base body 2 is disposed with a first microphone 22 and a first megaphone 23 on the side facing the visitor, and the inner base body 3 is disposed with a second microphone 32, a second megaphone 33, a door-opening key 34, and an attention key 35 on the side facing the indoor user. The first microphone 22 is electrically connected with the second megaphone 33, and the second microphone 32 is electrically connected with the first megaphone 23, so that the visitor outside the door may have a conversation with the user inside the door, and the user inside the door may control the electronic lock to release the locking state by pressing the door-opening key 34, or to emit an attention signal by pressing the attention key 35.

The inner base body 3 is disposed with a circuit board 36, and the circuit board 36 is disposed with a memory 37. The memory 37 is electrically connected with the image pickup element 21, so as to record and store the image obtained by the image pickup element 21, and enable the user to know which visitors paid a visit before through display of the screen 31. During implementation, the circuit board 36 and the memory 37 may also be disposed on the outer base body 2, and also have the function of storing and recording the image.

FIG. 3 shows a second embodiment of the electronic lock 1 with the screen according to the present invention. Referring to FIG. 3, differences between the second embodiment and the first embodiment lie in the following. The inner base body 3 includes a base 4 and a mobile machine body 5. The base 4 is disposed with a signal receiver 41, the signal receiver 41 is connected with a switch 42, and the switch 42 is electrically connected with the magnetic valve 24 and the power supply. A USB socket 43 and an approximately L-shaped bearing portion 44 are disposed at a bottom of the base 4, and the USB socket 43 is electrically connected with the circuit board 36. The mobile machine body 5 is approximately rectangular parallelepiped shaped. A signal transmitter 51 is disposed at a top of the mobile machine body 5 for controlling the door 9 to be unlocked after outputting a signal to the signal receiver 41. During implementation, the signal receiver 41 is an infrared signal receiver, and the signal transmitter 51 is an infrared signal transmitter, the signal receiver 41 may also be a Bluetooth signal receiver, and the signal transmitter 51 is a Bluetooth signal transmitter, which may also control the door to be unlocked. In addition, a USB plug 52 is disposed at a bottom of the mobile machine body 5, so that the USB plug 52 is plugged in the USB socket 43 at the same time when the mobile machine body 5 is plugged in and positioned on the bearing portion 44 of the base 4. In addition, the mobile machine body 5 is disposed with a rechargeable battery 53, and the rechargeable battery 53 is electrically connected with the USB plug 52, so that the USB plug 52 may be used to perform charging and data transmission.

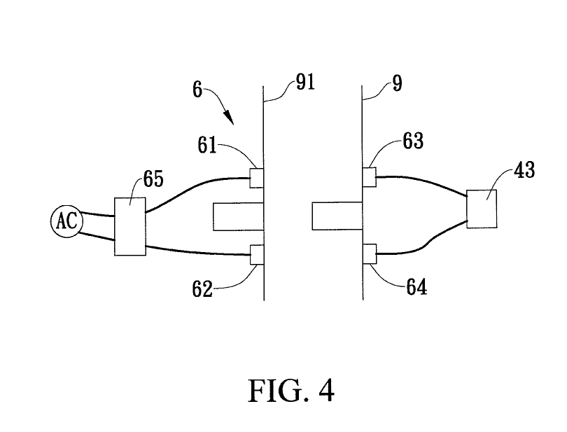

Referring to FIG. 4, a power supply component 6 is used to supply power to the rechargeable battery 53 in the present invention. The power supply component 6 includes a first upper contacting portion 61, a first lower contacting portion 62, a second upper contacting portion 63, and a second lower contacting portion 64. The first upper contacting portion 61 and the first lower contacting portion 62 are positioned at a side edge of a door frame 91, and are respectively electrically connected with a commercial power, in which the commercial power is converted from an Alternating Current (AC) voltage into a Direct Current (DC) voltage through a rectifier and voltage step-down circuit 65. The second upper contacting portion 63 and the second lower contacting portion 64 are positioned at a side edge of the door 9 in the door frame 91. The second upper contacting portion 63 corresponds to the first upper contacting portion 61, the second lower contacting portion 64 corresponds to the first lower contacting portion 62, and the second upper contacting portion 63 and the second lower contacting portion 64 are respectively electrically connected with the USB socket 43. Therefore, when the user closes the door, the first upper contacting portion 61 and the second upper contacting portion 63 are conducted, and the first lower contacting portion 62 and the second lower contacting portion 64 are conducted. In addition, the rechargeable battery 53 is charged after the USB plug 52 of the mobile machine body 5 is plugged in the USB socket 43.

Therefore, the present invention has the following advantages.

1. A cost for purchasing an interphone with a screen and an electronic lock is reduced, and time for respectively installing the interphone and the electronic lock is effectively decreased.

2. An indoor user may know an identity of a visitor paying a visit in real time in every indoor corner or floor, and control the electronic lock to be unlocked via remote control, so the present invention is quite convenient in use and operation.

3. Images of visitors paid a visit before are stored, and are displayed on a screen of an indoor inner base body, so the visitors may be effectively filtered, and the user may determine whether to make a reply according to the images.

According to the aforementioned disclosure, the present invention surely can achieve the expected objectives to provide an electronic lock with a screen which has functions of the electronic lock, enables the indoor person to know the current visitor or visitors paid a visit before, and reduces the purchasing cost and the installation time, which undoubtedly has the practical value. Thus, the patent application is filed according to the law.

While the present invention has been described with reference to the embodiments and technical means thereof, various changes and modifications can be made based on the disclosure or teachings described herein. Any equivalent changes made based on the concepts of the present invention having their effect without departing from the spirit encompassed by the specification and drawings should be construed as falling within the scope of the invention as defined by the appended claims.

1. An electronic lock with a screen, comprising an outer base body and an inner base body, wherein the outer base body and the inner base body are correspondingly installed on inner and outer sides of a door for controlling the door to be open or locked, wherein:
the outer base body is disposed with an image pickup element for obtaining an image of a visitor standing outside the door; and
the inner base body is disposed with a screen electrically connected with the image pickup element for displaying the image obtained by the image pickup element.

2. The electronic lock with a screen according to claim 1, wherein the outer base body is disposed with a first microphone and a first megaphone, the inner base body is disposed with a second microphone and a second megaphone, the first microphone is electrically connected with the second megaphone, and the second microphone is electrically connected with the first megaphone, so that the visitor outside the door has a conversation with a user inside the door.

3. The electronic lock with a screen according to claim 1, wherein the inner base body comprises a base and a mobile machine body, and the base is disposed with a bearing portion for connecting the mobile machine body to the base.

4. The electronic lock with a screen according to claim 1, wherein the inner base body is disposed with a circuit board, and the circuit board is disposed with a memory electrically connected with the image pickup element for recording the image obtained by the image pickup element.

5. The electronic lock with a screen according to claim 3, wherein the base is disposed with a socket, the mobile machine body is disposed with a plug for being correspondingly plugged in the socket, and the mobile machine body is disposed with a rechargeable battery electrically connected with the plug.

6. The electronic lock with a screen according to claim 5, wherein the socket is a Universal Serial Bus (USB) socket, and the plug is a USB plug.

7. The electronic lock with a screen according to claim 5, further comprising a power supply component, wherein the power supply component comprises a first upper contacting portion, a first lower contacting portion, a second upper contacting portion, and a second lower contacting portion, the first upper contacting portion and the first lower contacting portion are positioned at a side edge of a door frame, and are respectively electrically connected with a commercial power, the second upper contacting portion and the second lower contacting portion are positioned at a side edge of the door, the second upper contacting portion corresponds to the first upper contacting portion, the second lower contacting portion corresponds to the first lower contacting portion, and the second upper contacting portion and the second lower contacting portion are respectively electrically connected with the socket for charging the rechargeable battery after the plug of the mobile machine body is plugged in.

8. The electronic lock with a screen according to claim 3, wherein the outer base body is disposed with a magnetic valve, the magnetic valve is connected with a power supply for controlling the door to be open or locked, the base is disposed with a signal receiver, the signal receiver is connected with a switch, the switch is electrically connected with the magnetic valve and the power supply, and the mobile machine body is disposed with a signal transmitter for controlling the door to be open after outputting a signal to the signal receiver.

9. The electronic lock with a screen according to claim 8, wherein the signal receiver is an infrared signal receiver, and the signal transmitter is an infrared signal transmitter.
